(19) United States
(12) Patent Application Publication
(10) Pub. No.: US 2001/0004742 A1
(43) Pub. Date: Jun. 21, 2001

(54) Service system for administering, storing, retrieving and distributing one's own information over network all the time from the present moment up to future

(76) Inventor: Kiyoshi Oike, Kawaguchi (JP)

Correspondence Address: KING AND SCHICKLI, Corporate Gateway, Suite 210, 3070 Harrodsburg Road, Lexington, KY, 40503, US

(21) Appl. No.: 09/742,245

(22) Filed: Dec. 20, 2000

(30) Foreign Application Priority Data
Dec. 21, 1999 (JP) 11-362556

(51) Int. Cl. G06F 15/16; G06F 15/167

(52) U.S. Cl. 709/206; 709/203; 709/214

(57) ABSTRACT

A service system for distributing one's own records or specific dates through a diary and a post using a network. This service system is featured in that the registration of password is executed in an information storage box of the individual such as an original home page of a network such as an internet, thereby creating one's own diary and mail box relevant to the password for entering future information; the password is input in inputting or outputting any information thereafter; a recorded date is input in the diary and the information occurred on that date is described in the column of that date; a designated future distribution date is input in the mail box and the information on the designation date is described in the column of the designation date; the information thus described is transmitted to the information storage box to store the information therein; the retrieval and distribution of information of the designated data from the information storage box is received by the diary; and the information is optionally and automatically distributed from the information storage box on a designated distribution date.

### BACKGROUND OF THE INVENTION

This invention relates to a service system for administering, storing, retrieving and distributing one's own information over a network all the time from the present moment up to future, wherein a network such as an internet is utilized, and a diary or a mail box which one can utilize for a desired period of time, e.g. full lifetime is individually prepared, thereby enabling the individual to optionally and automatically receive a distribution service about records of one's memories or about necessary information on the date of events or meetings, etc. which one wants to know.

The conventional mail utilizing the internet is fundamentally confined to enabling an individual to transmit an information from him to other persons or to obtain other's information.

### BRIEF SUMMARY OF THE INVENTION

Therefore, an object of this invention is to provide a service system for administering, storing, retrieving and distributing one's own information over a network all the time from the present moment up to future, wherein a diary (a network diary) or a mail box (a network mail box) which one can utilize for a desired period of time, e.g. full lifetime is individually prepared to thereby enable the individual to store or obtain his information over a network such as an internet, thus making it possible for the individual to optionally and automatically receive a distribution service about records of one's memories or about necessary information on the date of events or meetings, etc. which one wants to know.

This invention has been accomplished in view of the aforementioned circumstances.

Namely, this invention provides a service system for administering, storing, retrieving and distributing one's own information over a network all the time from the present moment up to future, which is featured in that; the registration of password is executed in an information storage box of the individual such as an original home page that has been built up on a network such as an internet, thereby creating one's own diary and one's own mail box relevant to the password for entering future information of short or long term; the password is required to be input on an occasion of inputting or outputting any information thereafter; a recorded date is input in the diary and the information occurred on the recorded date is described in the column of the recorded date; a designated future distribution date is input in the mail box and the information on the designation date is described in the column of the recorded designation date; the information thus described is transmitted to the information storage box to store the information therein; the retrieval and distribution of information of the designated data from the information storage box is designed to be received by the diary; and the information is optionally and automatically distributed from the information storage box on a designated distribution day which is stored in the mail box.

### BRIEF DESCRIPTION OF THE SEVERAL VIEWS OF THE DRAWING

FIG. 1 is a diagram schematically illustrating the service system representing one embodiment of this invention.

### DETAILED DESCRIPTION OF THE INVENTION

Next, this invention will be explained with reference to the drawing.

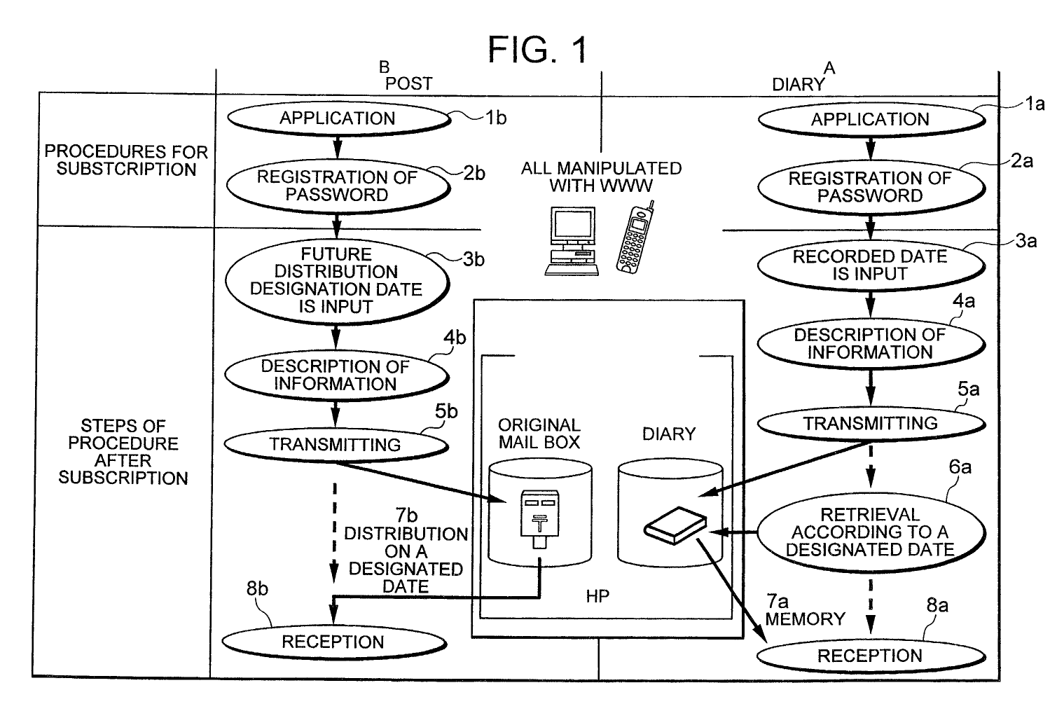

FIG. 1 is a diagram schematically illustrating the service system representing one embodiment of this invention, which is featured in that any individual who wishes to utilize the service system makes applications 1a and 1b first of all. Then, in response to the applications made by the individual, the registrations 2a and 2b of one's own password are executed for a diary A as well as for a mail box B, thereby creating, in one's home page, a diary for administrating one's own date and a mail box for storing information relevant to the password.

On the occasion of inputting or outputting any information thereafter, the password is required to be input in advance in order to manipulate the information. By making use of the diary A, a recorded date is input (3a) therein, and the information occurred on that day is described (4a) in the column of the recorded date.

By making use of the mail box B, a designated future distribution date is input (3b) therein, and the information of that designated date is described (4b) in the column of the designated date that has been recorded.

The information that has been described (4a and 4b) in the mail box is transmitted (5a and 5b) to and stored in the home page HP.

By making use of the diary A, a retrieval (6a) is performed according to the designated date, thereby retrieving an information. It is also possible to receive (8a) the distribution of information (7a) from the home page HP.

By making use of the mail box B, it is possible to optionally or automatically receive (8b) the distribution of information (7b) of the designated date from the home page HP on the distribution designation day.

As explained above, according to the service system for administering, storing, retrieving and distributing one's own information over a network all the time from the present moment up to future, the registration of password is executed by making use of the information storage box of the individual such as an original home page that has been built up on a network such as an internet, thereby creating one's own diary and one's own mail box relevant to the password for entering future information of short or long term. In this case, the password is required to be input on an occasion of inputting or outputting any information thereafter. This service system is further featured in that a recorded date is input in the diary and the information occurred on the recorded date is described in the column of the recorded date, that a designated future distribution date is input in the mail box and the information on the designation date is described in the column of the recorded designation date, that the information thus described is transmitted to the information storage box to store the information therein, that the retrieval and distribution of information of the designated data from the information storage box is designed to be received by the diary; and that the information is optionally and automatically distributed from the information storage box on a designated distribution day which is stored in the mail box. Therefore, it is possible, by making use of the diary, to store and keep records such as the events or memories of a predetermined period or all of one's life over a period of as long as millennium unit if such events or memories are described and kept in the diary that has been created in a network.

Further, the data that have been stored in the information storage box can be only retrieved by the individual assigned with his own registered address and password. Therefore, it is possible to utilize the service system as a one's life diary starting from his birthday or as a record book of memories. It is also possible to utilize the service system for storing the events of a company or for storing various information such as a workshop diary or a wage record, thereby making it possible to look back the past records. Accordingly, this service system can be extensively utilized for use in private, in home or in a company.

As for the mail box, any future events related to the individual or any information which should never be forgot may be mailed in his own mail box created over the network, thereby enabling any required information to be received by him on the designated day. Such an information may be repeatedly delivered to him every year on the designated day or on a day before the designated day.

Furthermore, this service system can be extensively utilized for use in private, in home or in a company, for example, for reminding the individual of the expiration date of a 30-year insurance, of the renewal date of a license, of the event or memorial day of one's home, of the anniversary for the establishment of client's company, of the renewal date of business license, of the procedure of registration, or of the final day of lease.

Therefore, the following effects can be obtained by this service system.

1. It is possible for the individual to logically create his own specific mail box or diary over a network.

2. It is possible for the individual utilize this service system for an indefinite period as long as his address and password are allowed to retained and if the restriction regarding the use period is not imposed thereon.

3. It is possible to utilize this service system through a conventional personal computer, potable telephone (having the function of mail), any other portable terminal device.

4. It is also possible to utilize this service system through a popular internet-accessible television or through a popular ITS-accessible navigation system of automobile.

5. This service system would be of great utility value in the case where there are frequent changes in one's address or frequent business trips.

6. Since the records are left on a network, it is possible to preserve an information for a long period of time. Furthermore, in contrast to the case where a recording of information is made on paper, this system is free from the loss of information and is also advantageous in preserving the secrecy of information and protecting the information (it is possible to prevent the information from being leaked to the others).

1. A service system for administering, storing, retrieving and distributing one's own information over a network all the time from the present moment up to future, which is featured in that;
the registration of password is executed in an information storage box of the individual such as an original home page that has been built up on a network such as an internet, thereby creating one's own diary and one's own mail box relevant to the password for entering future information of short or long term;
the password is required to be input on an occasion of inputting or outputting any information thereafter;
a recorded date is input in the diary and the information occurred on the recorded date is described in the column of the recorded date;
a designated future distribution date is input in the mail box and the information on the designation date is described in the column of the recorded designation date;
the information thus described is transmitted to the information storage box to store the information therein;
the retrieval and distribution of information of the designated data from the information storage box is designed to be received by the diary; and
the information is optionally and automatically distributed from the information storage box on a designated distribution day which is stored in the mail box.
